(19) United States
(12) Patent Application Publication
(10) Pub. No.: US 2010/0098542 A1
(43) Pub. Date: Apr. 22, 2010

(54) Wind Turbine Having Two Sets of Air Panels to Capture Wind Moving in Perpendicular Direction

(76) Inventor: Stanley C. Jonsson, San Mateo, CA (US)

Correspondence Address: GORDON & REES LLP, 101 WEST BROADWAY, SUITE 1600, SAN DIEGO, CA, 92101, US

(21) Appl. No.: 12/254,726

(22) Filed: Oct. 20, 2008

(51) Int. Cl. F03D 3/06; F03D 3/00

(52) U.S. Cl. 416/140; 416/141

(57) ABSTRACT

A wind turbine, having: (a) a rotatable frame; (b) a plurality of first air panels mounted to the rotatable frame, the plurality of first air panels extending in a direction parallel to an axis of rotation of the rotatable frame; (c) a plurality of second air panels mounted to the rotatable frame, the plurality of second air panels extending in directions radial to the axis of rotation of the rotatable frame; and (d) a base shaped to direct air flow received from a direction radial to the axis of rotation of the rotatable frame into a direction parallel to the axis of rotation of the rotatable frame. A system for positioning airfoils on a rotating frame wind turbine, having: a rotating frame; a plurality of airfoils pivotally connected to the rotating frame; a pair of positional stops for each airfoil on the rotating frame, wherein the pair of positional stops are located to limit rotation of the airfoil such that the airfoil is positioned in a high-drag position as the airfoil moves with the wind, and in a low drag position as the airfoil moves against the wind.

### TECHNICAL FIELD

The present invention relates generally to electricity producing wind turbines

### BACKGROUND OF THE INVENTION

Many conventional wind turbine designs already exist for producing electricity. Most commonly, such designs involve a single large propeller mounted at the top end of a vertical mast. Air flow across the propeller causes the propeller to turn, which in turn rotates a generator to produce electricity.

Such conventional wind turbines suffer numerous disadvantages. First, they involve large propellers that must be mounted a considerable distance above the ground. Thus, they require a tall and sturdy mast to which the propeller is mounted. A second disadvantage of large rotating propeller blade systems is that they tend to kill a large number of birds. A third disadvantage of such designs is that the generator is typically positioned at the center of the rotating blades. Thus, the generator is mounted at the top of the mast along with the propeller. This requires the mast to be sufficiently strong to support both the propeller and the generator. As a result, it is difficult to access the turbine for repairs and servicing. A fourth disadvantage of conventional propellers is that the blades rotate in a direction perpendicular to the wind direction. As a result, propeller blade velocity through the air increases with the distance from the center of rotation of the propeller. This unfortunately requires a variable and complex blade section geometry.

### SUMMARY OF THE INVENTION

The present invention provides a wind turbine, comprising: (a) a rotatable frame; (b) a plurality of first air panels mounted to the rotatable frame, the plurality of first air panels extending in a direction parallel to an axis of rotation of the rotatable frame; (c) a plurality of second air panels mounted to the rotatable frame, the plurality of second air panels extending in directions radial to the axis of rotation of the rotatable frame; and (d) a base shaped to direct air flow received from a direction radial to the axis of rotation of the rotatable frame into a direction parallel to the axis of rotation of the rotatable frame.

Preferably, the first plurality of air panels and the second plurality of air panels are perpendicular to one another, and the base is curved inwardly narrowing along the direction of the axis of rotation of the rotatable frame. In operation, the first plurality of air panels capture wind moving in a direction perpendicular to the axis of rotation of the rotatable frame and the second plurality of air panels capture wind moving in a direction parallel to the axis of rotation of the rotatable frame. For example, the first plurality of air panels capture wind moving in a horizontal direction while the second plurality of air panels capture wind moving in a vertical direction. In alternate embodiments, the various airfoils may be flat panels, curved scoops, “airfoil shaped” (like an airplane wind), or some combination of the above.

As can be seen in the attached figures, the frame preferably in a horizontal direction about a vertical axis. In addition, the frame is preferably set high enough above the ground surface to permit air flow both above and below the rotating frame.

In accordance with an embodiment of the present invention, air flow along the ground is captured by both the first and second sets of air panels, causing the wind turbine to rotate. Specifically, wind moving along the ground is captured by the first set of air panels (which stand vertically around the periphery of the rotatable frame). These first set of air panels may be flat, curved or airfoil shaped. In addition, however, air flow along the ground also comes into contact with the curved base of the turbine and is directed upwardly into the turbine. In this regard, the second set of air foils captures the air directed upwardly into the wind turbine, also causing the rotatable frame of the turbine to rotate. The second set of air panels may be disposed inside the periphery of the rotatable frame. In addition, a dark colored ground plate may be included, to warm air adjacent the base of the bottom of the turbine, thereby sending air up towards the second set of air panels. Together, the air flow horizontally across the first air panels and vertically across the second air panels causes the rotatable frame to rotate.

In optional embodiments, a ground plate is positioned to extend outwardly from the bottom of the base. This ground plate may be black, or darkly colored to absorb solar energy and warm air above the ground plate.

An advantage of the present invention is that is uses air flow in perpendicular directions for power. I.E. both airflow horizontally along the ground, and air flow passing vertically up into the turbine is used for power.

Another advantage of the present invention is that a generator drive wheel may be positioned to contact the outer perimeter of the rotatable frame of the device. In contrast, existing wind turbines operate with their generator drive in contact with a rotating mechanism that is disposed at the center of a rotating propeller. As a result, the present system offers gearing advantages due to the comparatively large sized circular frame in contact with the comparatively small sized drive wheel. As a result, power is efficiently generated by the wind turbine due to minimal friction losses translating power into generator rotation. It is to be understood, however, that the present invention also encompasses embodiments where the generator drive is in contact with a rotating mechanism at the center of the rotatable frame.

In further alternate embodiments, the rotating frame is the rotor of the generator. By placing magnets on the rotating frame, and having them rotate past fixed coils would induce a current in the coils. An advantage of this embodiment is that it would eliminate a drive wheel, drive shaft and generator. This minimizes complexity and maintenance.

Yet another advantage is that the present invention has a low center of gravity. Therefore, the present wind turbine is very stable. Moreover, the present system does not require a strong, heavy mast to support a propeller and turbine some distance above the ground. This considerably reduces the weight and size limitations of the present system, resulting in cost savings as compared to traditional designs. Furthermore, having the generator drive wheel (and the turbine itself) positioned close to the ground permits easy access for turbine/drive system repairs and servicing.

In accordance with the present invention, the air panels may be flat, curved scoops or “airfoil shaped” (i.e. like an airplane wing). In those embodiments where the air panels are airfoil shaped, both “lift” and “drag” effects may be used to turn the rotatable frame (depending upon the position of the airfoil). Specifically, lift caused by air flow over the airfoil causes the rotatable frame to rotate when the airfoils are oriented such that their leading and trailing edges are aligned with the direction of the wind when the airfoil is positioned furthest into the direction of the wind. In addition, drag caused by air flow over the airfoil causes the rotatable frame to rotate when the leading and trailing edges of the airfoil are perpendicular to the direction of the wind when the airfoil is moving in the direction of the wind. Stated another way, the airfoils can be “feathered” such that the airfoils produce more positive torque when rotating with the wind than the airfoils that are rotating against the wind.

A second advantage of using an airfoil shape panel is that each of the airfoils experience the same wind velocity along the entire length of their leading edge. Equal wind velocity at all points along the leading edge of the airfoil allows a single simplified airfoil cross section along the entire airfoil length. Thus, the wind turbine horizontal width and not its vertical diameter determines power generation. Moreover, having the airfoils disposed at the perimeter of the device results in the longest possible torque lever arm. This results in the most torque per unit of airfoil force generation.

A third advantage of using airfoil shaped air panels is that the same airfoil cross section can be used across the entire width of the airfoil. Therefore, power output of the wind turbine can be increased simply by increasing the width of the airfoils. Since the airfoil will have a single simplified cross section, the power output can be increased simply by increasing the airfoil length. In contrast, with conventional propeller systems, it is necessary to increase the diameter of the propellers to increase system power output.

The present invention also provides a system for positioning airfoils on a rotating frame wind turbine, comprising: a rotatable frame; a plurality of airfoils pivotally connected to the rotatable frame; a pair of positional stops for each airfoil on the rotatable frame, wherein the pair of positional stops are located to limit rotation of the airfoil such that the airfoil is positioned in a high-drag position as the airfoil moves with the wind, and in a low drag position as the airfoil moves against the wind.

### BRIEF DESCRIPTION OF THE DRAWINGS

FIG. 1 is a perspective view of the present invention.

FIG. 2 is a sectional side elevation view of the present invention.

FIG. 3 is a top plan view of the present invention.

FIG. 4 is top plan view of a second embodiment of the present invention.

FIG. 5 is a top plan view of a third embodiment of the present invention.

FIG. 6 is a perspective view of a fourth embodiment of the present invention.

FIG. 7 is a sectional view taken along line 7-7 in FIG. 6.

FIG. 8 is a sectional view similar to FIG. 7, but showing an alternate embodiment.

FIGS. 9A to 9D are top plan views of an automatically rotating airfoil mounted to a rotatable frame of a wind turbine, showing sequential pivoting movement of the rotating airfoil with respect to the rotatable frame.

### DETAILED DESCRIPTION OF THE DRAWINGS

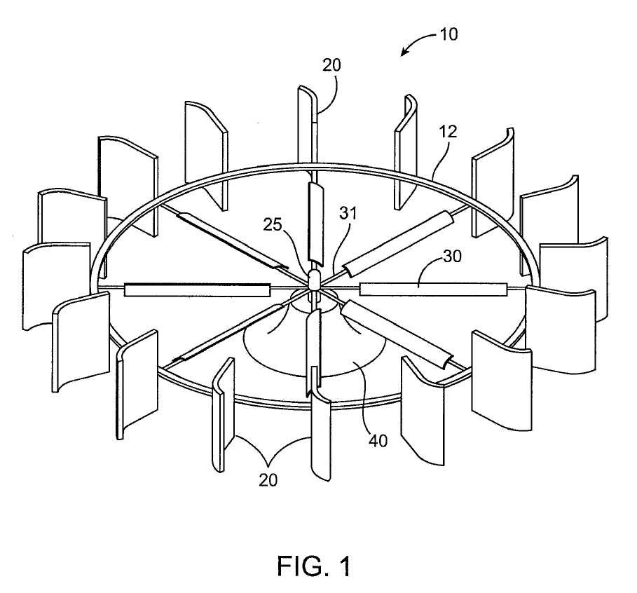

As seen in FIGS. 1 to 3, the present invention provides a wind turbine 10. Wind turbine 10 comprises: a rotatable frame 12; a plurality of first air panels 20 mounted to rotatable frame 10; and a plurality of second air panels 30 mounted to rotatable frame 12. The plurality of first air panels 20 extend in a direction parallel to axis of rotation A of rotatable frame 12. As illustrated in this example, first air panels 20 extend in a vertical direction. The plurality of second air panels 30 extend in directions radial to axis A. As illustrated in this example, second air panels 30 extend in a horizontal direction.

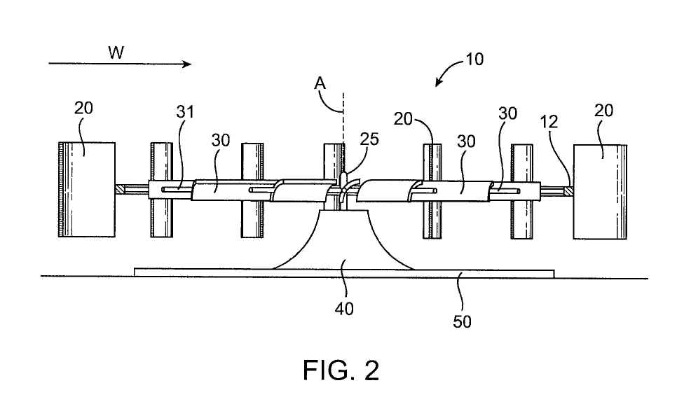

A base 40 is also included. Base 40 is shaped to direct air flow received from a direction radial to the axis of rotation of the rotatable frame (i.e.: wind W) into a direction parallel to axis of rotation A. As seen in FIG. 2, wind W is horizontal, and base 40 causes the wind striking base 40 to be directed upwardly (in a vertical direction) into the bottom of turbine 10. Specifically, the shape of base 40 causes wind W to be directed upwardly to pass across second air panels 30.

As can be seen, first air panels 20 and second air panels 30 are disposed perpendicular to one another, with first air panels 20 being disposed around the periphery of rotatable frame 12, and second air panels 30 being disposed inside the periphery of rotatable frame 12. As can be seen, the first air panels 20 are configured to capture wind moving in a direction perpendicular to axis A and the second air panels 30 are configured to capture wind moving in a direction parallel to axis A.

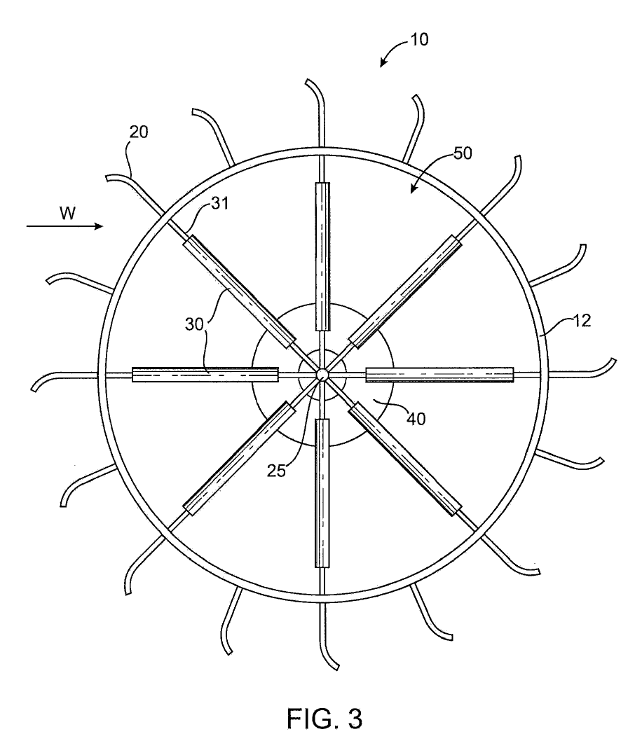

Rotatable frame 12 may comprise a circular hoop supported by a plurality of spokes 31 connected to a central rotating vertical post 25. In this exemplary embodiment, second air panels 30 may be mounted onto (or between) spokes 31. Air flow in the horizontal direction (wind W) is caught by the first air panels 20, causing the rotatable frame 12 to rotate. (In the embodiment of the invention shown in FIG. 3, first air panels 20 are shaped as cups or scoops to catch this horizontal air movement).

Base 40 is curved inwardly narrowing along the direction of axis of rotation A of rotatable frame 12. Base 40 is preferably concave, and symmetrical around axis A, as shown. As such, a portion of the wind hitting base 40 is directed upwardly across air panels 30 (which may be flat, curved or airfoil shaped). The movement of air vertically upward (in the direction of rotational axis A) across air panels 30 also causes rotatable frame 12 to rotate. As such, vertical air flow into the bottom of the wind turbine (across air panels 30) compliments horizontal airflow across the wind turbine (across air panels 20). Thus, air panels 20 and 30 work together to cause rotatable frame 12 to rotate in direction R.

As can also be seen, a ground plate 50 may also be included. Ground plate 50 is positioned to extend outwardly from the bottom of base 40, as shown. Preferably, ground plate 50 is black or darkly colored to absorb solar energy, and thus warm the air above the ground plate. This warming of the air (above ground plate 50) will cause upward convection of the air, moving the air upwardly across air panels 30.

Warmed air will rise by convection into the bottom of rotatable frame 12. Thus, rotatable frame 12 is preferably mounted off of the ground so that ambient air or wind can be drawn into and enter under the bottom of rotatable frame 12, thereby replacing the warmed air rising into the bottom of rotatable frame 12.

In accordance with the present invention, the rotation of rotatable frame 12 can be used to generate electricity either by a generator in contact with rotating vertical post 25, or alternatively by contact with wheels supporting (underneath or to the side of) rotatable frame 12. In other alternate embodiments, rotating frame 12 is the rotor of a generator. By placing magnets on rotating frame 12, and having them rotate past fixed coils would induce a current in the coils.

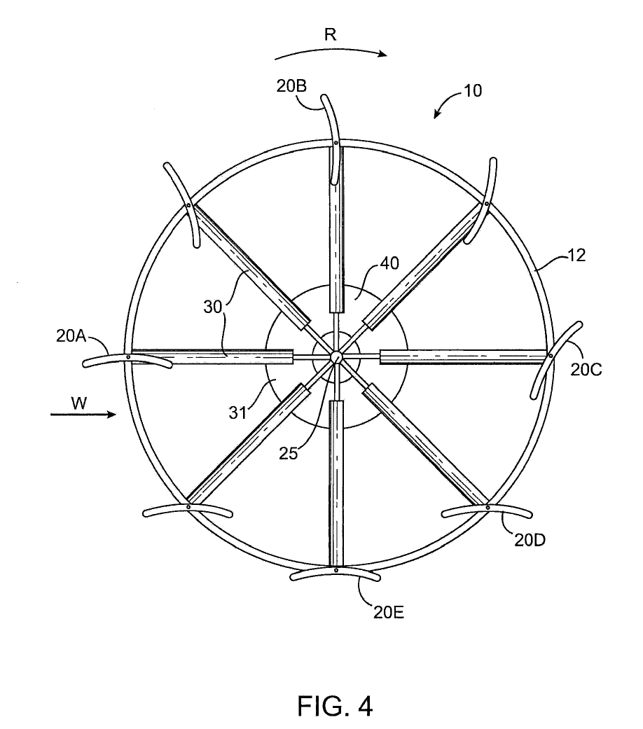

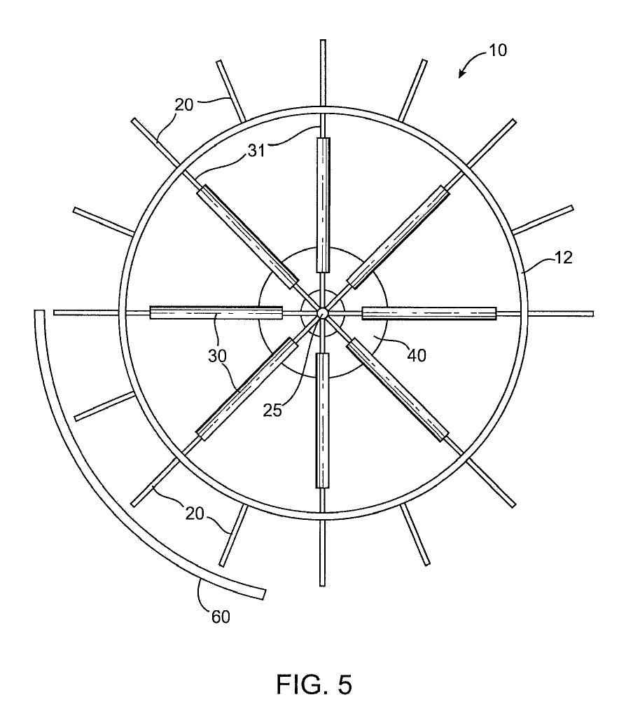

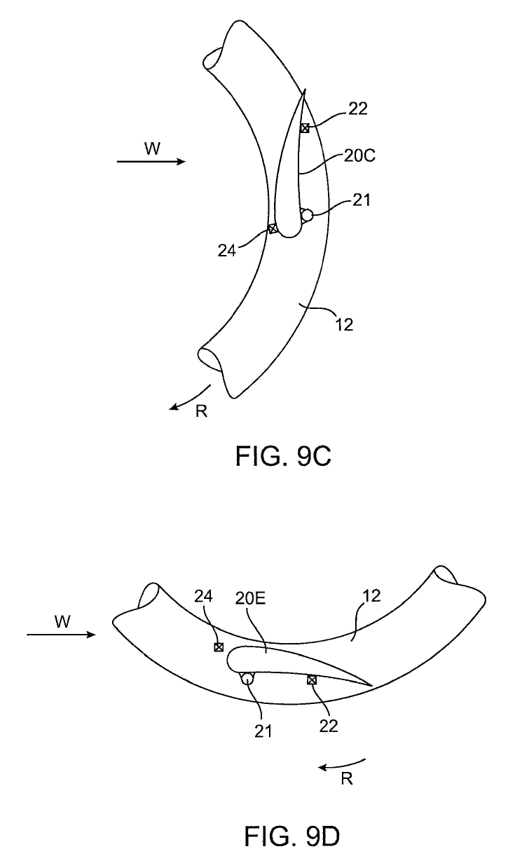

In various embodiments, air panels 20 may be curved scoops (as shown in FIGS. 1 to 3 and 6), or be airfoil shaped like the cross section of an airplane wing (as shown in FIGS. 4 and 9A to 9D), or be flat panels (as shown in FIG. 5).

Referring next to FIG. 4, air panels 20 are pivoted to rotate with respect to the rotatable frame 12. This embodiment may be similar in operation to the system seen in US Patent Publication 2007/0297902, incorporated herein by reference in its entirety for all purposes). In this embodiment, air panels 20 are pivoted to rotate from a position parallel to the wind (i.e. air panel 20A) at which lift is generated (to cause frame 12 to rotate) to a position perpendicular to the wind (i.e. air panel 20B) at which drag is generated (to cause frame 12 to rotate). Next, air panel “flips around” as it moves into the wind from positions 20C to 20D. In this embodiment, air panels 30 operate in the same manner as described above.

As such, rotatable frame 12 circles around axis A while the individual airfoils 20 pivot to point in different directions with respect to rotatable frame 12. For example, rotational stops (shown and fully described as element 24 in US Patent Publication 2007/0297902) may be provided to hold each of airfoils 20 in a high drag position when the airfoil 20 moves in the direction of air flow (i.e.: in direction W). These rotational stops selectively prevents rotation of airfoil 20 with respect to rotatable frame 12 at various locations when airfoil 20 rotates around axis A. At some locations, the rotational stop orients airfoil 20 at a position such that lift caused by air flow over airfoil 20 causes rotatable frame 12 to rotate. At other locations, the rotational stop orients airfoils 20 at a position such that drag caused by air flow over airfoil 20 causes rotatable frame 12 to rotate. Rotational stops limits pivoting of airfoils 20 with respect to rotatable frame 12 to prevent rotation of the individual airfoils 20 from a high drag position to a low drag position when the airfoil is moving in the direction of the air flow W. Optional guides and a channel (shown and fully described as elements 24 and 30 in US Patent Publication 2007/0297902) may also be used to position airfoils 20 at low drag positions as the airfoils 20 move in a direction opposite to the direction of air flow W.

As will be explained below, an alternate airfoil embodiment as seen in FIGS. 9A to 9D may be provided with airfoils that automatically pivot with respect to rotatable frame 12 (as rotatable frame 12 rotates) may also be provided. This alternate embodiment avoids the use of the optional guides and channel as was seen in US Patent Publication 2007/0297902 to control the pivoting movement the airfoils.

Referring next to the embodiment of FIG. 5, air panels 20 may instead be flat panels. In this embodiment, a baffle 60 may be included to block air flow over a portion (e.g.: half) of first air panels 20, such that frame 12 is rotated by the wind hitting half of the flat air panels 20, as shown. In this embodiment, baffle 60 may be positioned to only block a portion (e.g.: half) of first air panels 20, while permitting base 40 to direct airflow upwardly across second air panels 30.

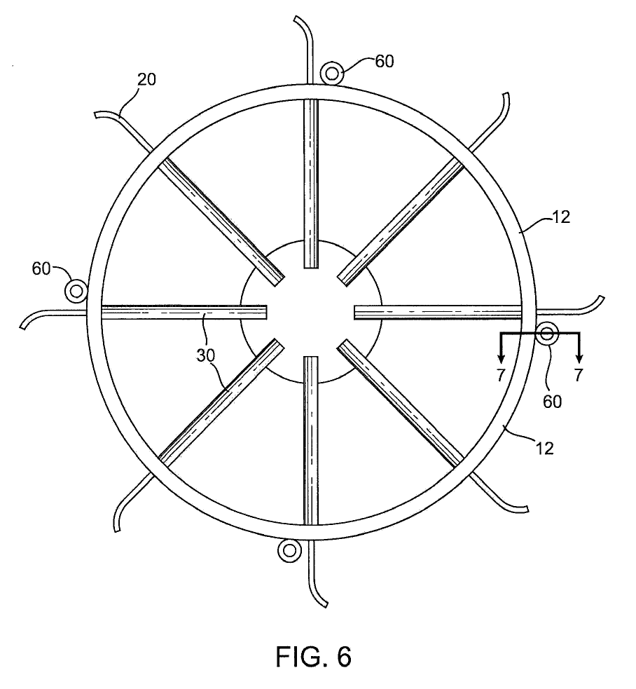

Referring to the embodiment of FIG. 6, rotatable frame 12 may be supported at its perimeter by wheels 60. The embodiment shown in FIG. 6 is similar to the embodiment shown in FIGS. 1 to 3, with the exception that spoke 31 are removed. Instead, air panels 30 are cantilevered directly onto rotatable frame 12. This design advantageously removes objects (i.e. spokes 31) from hindering convective air flow upward into the bottom of rotatable frame 12.

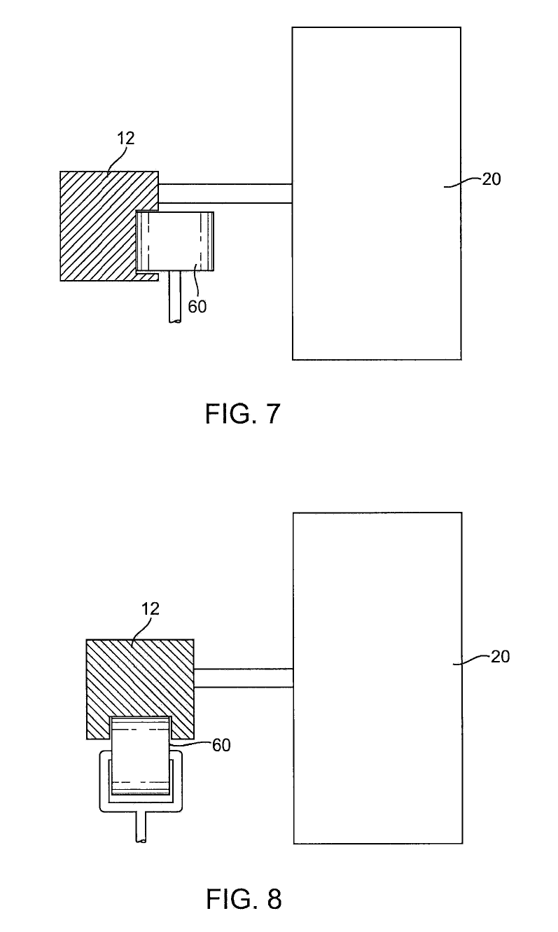

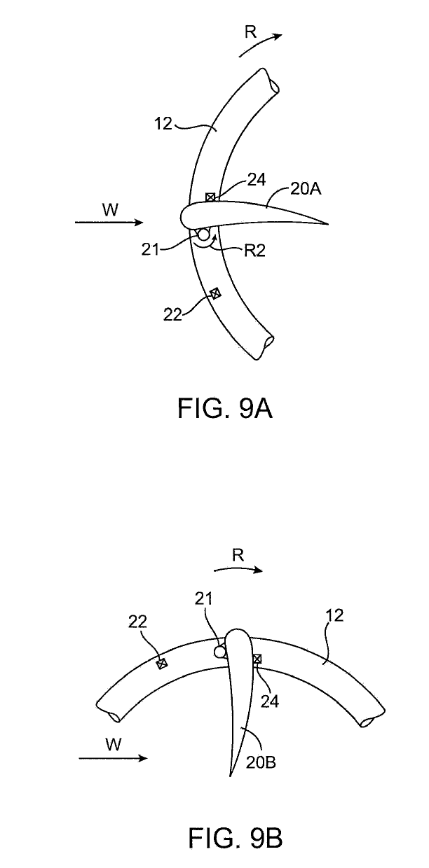

As previously illustrated, rotatable frame 12 may be supported by a single central rotating vertical post 25. However, as shown in FIG. 6, rotatable frame 12 may instead be supported by wheels 60 underneath and beside frame 12 (e.g.: similar to wheels 14 and 16 as seen in US Patent Publication 2007/0297902, incorporated herein by reference in its entirety for all purposes). FIG. 7 shows a sectional view taken along line 7-7 in FIG. 6. As can be seen, wheel 60 can be positioned to be received into an outer groove in rotatable frame 12. FIG. 8 shows a similar embodiment, but with wheels 60 positioned in a groove in the bottom of rotatable frame 12.

Lastly, FIGS. 9A to 9D show top plan views of an automatically rotating airfoil mounted to a rotatable frame of a wind turbine, showing sequential pivoting movement of rotating airfoil 20 with respect to rotatable frame 12 (as rotatable frame 12 moves). FIG. 9A shows airfoil 20 at the position 20A of FIG. 4. Airfoil 20 is connected to frame 12 by pivot 21. A pair of stops 22 and 24 are provided to restrain the motion of airfoil 20. Specifically, when the airfoil is at position 20A (FIG. 9A), wind W passing over airfoil 20 will cause the airfoil to “lift” into position such that the top of the airfoil contacts against stop 24 (rotating around pivot 21 in direction R2 while frame 12 moves in direction R). Airfoil 20A provides lift causing frame 12 to rotate in direction R. Next, airfoil 20 will reach the position 20B (FIG. 9B). At this position, airfoil 20B is oriented to provide considerable drag, again urging frame 12 to rotate in direction R. Next, airfoil 20 will reach position 20C. At this time, airfoil 20 will “flip over” such that the bottom of the airfoil now contacts stop 22. The positioning of airfoil at position 20C will also urge frame 12 to rotate in direction R. Finally, airfoil 20 reaches the position 20E shown in FIG. 9D. This positioning provides the least resistance to wind W as frame 12 rotates in direction R. Note, the positions of airfoils at 20A, 20B, 20C and 20E correspond to the same positions shown in FIG. 4.

As such, the present invention also provides system for positioning airfoils on a rotating frame wind turbine, comprising: a rotatable frame 12; a plurality of airfoils 20 pivotally connected to rotatable frame 12; a pair of positional stops 22 and 24 for each airfoil 20 on rotatable frame 12, wherein the pair of positional stops 22 and 24 are located to limit rotation of airfoil 20 such that airfoil 20 is positioned in a high-drag position as the airfoil moves with the wind (i.e. in direction W), and in a low drag position as the airfoil moves against the wind (i.e. opposite to direction W).

Preferably, the pair of positional stops 22 and 24 for each airfoil 20 comprises a first positional stop 24 on frame 12 that contacts a top of airfoil 20, and a second positional stop 22 on frame 12 that contacts the bottom of airfoil 20. As can be seen, the location 21 on frame 12 about which airfoil 20 pivots is closer to first stop 24 than to second stop 22.

An advantage of the airfoil positioning system of FIGS. 9A to 9D is that airfoils 20 rotate without any need of the optional guides and channel (as seen in US Patent Publication 2007/0297902).

Although the present wind turbine is shown in a horizontal orientation (i.e.: rotating about a vertical axis of rotation A), the present invention can also be constructed in a vertical orientation (i.e.: rotating about a horizontal axis of rotation).

What is claimed is:

1. A wind turbine, comprising:
(a) a rotatable frame;
(b) a plurality of first air panels mounted to the rotatable frame, the plurality of first air panels extending in a direction parallel to an axis of rotation of the rotatable frame;
(c) a plurality of second air panels mounted to the rotatable frame, the plurality of second air panels extending in directions radial to the axis of rotation of the rotatable frame; and
(d) a base shaped to direct air flow received from a direction radial to the axis of rotation of the rotatable frame into a direction parallel to the axis of rotation of the rotatable frame.

2. The wind turbine of claim 1, wherein the first plurality of air panels and the second plurality of air panels are perpendicular to one another.

3. The wind turbine of claim 1, wherein the first plurality of air panels are disposed around the periphery of the rotatable frame.

4. The wind turbine of claim 1, wherein the second plurality of air panels are disposed inside the periphery of the rotatable frame.

5. The wind turbine of claim 1, wherein the base is curved inwardly narrowing along the direction of the axis of rotation of the rotatable frame.

6. The wind turbine of claim 5, wherein the base is concave.

7. The wind turbine of claim 1, wherein the base is symmetrical around the axis of rotation of the rotatable frame.

8. The wind turbine of claim 1, further comprising a ground plate positioned to extend outwardly from the bottom of the base.

9. The wind turbine of claim 10, wherein the ground plate is darkly colored to absorb solar energy and warm air above the ground plate.

10. The wind turbine of claim 1, wherein the air panels are curved scoops.

11. The wind turbine of claim 1, wherein the air panels are airfoil shaped.

12. The wind turbine of claim 11, wherein the air panels are pivoted to rotate with respect to the rotatable frame.

13. The wind turbine of claim 1, further comprising a baffle configured to block air flow over a portion of the plurality of the first air panels.

14. The wind turbine of claim 13, wherein the baffle blocks air flow over half of the plurality of the first air panels.

15. The wind turbine of claim 13, wherein the baffle directs airflow towards a back portion of the rotatable frame.

16. The wind turbine of claim 1, wherein the first plurality of air panels are configured to capture wind moving in a direction perpendicular to the axis of rotation of the rotatable frame and the second plurality of air panels are configured to capture wind moving in a direction parallel to the axis of rotation of the rotatable frame.

17. A system for positioning airfoils on a rotating frame wind turbine, comprising:
a rotating frame;
a plurality of airfoils pivotally connected to the rotating frame;
a pair of positional stops for each airfoil on the rotating frame, wherein the pair of positional stops are located to limit rotation of the airfoil such that the airfoil is positioned in a high-drag position as the airfoil moves with the wind, and in a low drag position as the airfoil moves against the wind.

18. The system of claim 17, wherein the pair of positional stops for each airfoil comprises a first positional stop on the frame that contacts a top of the airfoil, and a second positional stop on the frame that contacts the bottom of the airfoil.

19. The system of claim 17, wherein the location on the frame about which the airfoil pivots is closer to the first stop than to the second stop.
